(19) United States
(12) Patent Application Publication
(10) Pub. No.: US 2018/0047092 A1
(43) Pub. Date: Feb. 15, 2018

(54) COMMUNICATING CONFIGURATION INFORMATION FOR AN APPLICATION FROM AN ONLINE SYSTEM TO THE APPLICATION BASED ON CONTEXTUAL INFORMATION FROM A CLIENT DEVICE EXECUTING THE APPLICATION

(71) Applicant: VenueNext, Inc., Santa Clara, CA (US)

(72) Inventors: Peter M. Hennessy, Novato, CA (US); William Malizia, Philadelphia, PA (US); Blane Cordes, Astoria, NY (US); John M. Paul, Palo Alto, CA (US)

(21) Appl. No.: 15/236,285

(22) Filed: Aug. 12, 2016

(51) Int. Cl. G06Q 30/06

(52) U.S. Cl. CPC G06Q 30/0641

(57) ABSTRACT

An application executing on a client device provides enhanced services at a venue (e.g., ticketing, food orders, etc.). To allow a single application to be used for multiple venues or to provide different functionality to different users of a single venue, the application downloads a configuration file from a venue management system. The configuration file identifies functions authorized to be performed by the application. Additionally, the configuration file specifies an appearance of an interface provided by the application based on contextual information obtained by the application. Examples of contextual information include a time of day, a location, a venue identifier, a device identifier, and a user identifier (e.g., a username). Configuring the application based on obtained configuration file avoids users downloading and updating multiple applications for different venues or to provide different functionality.

### BACKGROUND

This invention relates generally to identifying products provided by vendors associated with a venue, and more specifically to a venue management system generating an interface by applying formatting rules to product information provided by vendors.

Various online systems allow users to access or to modify information maintained by an online system by providing applications to client devices. By interacting with an application associated with the online system that executes on a client device, a user may access information maintained by the online system or may provide information to the online system. However, online systems often limit functionality provided by the application to different users. For example, different employees of an organization are authorized to perform different actions, so applications used by certain employees provide different functionality than the functionality provided by applications used by other employees.

Conventionally, different applications with different functionality are provided to users based on the actions the users are authorized to perform. While this allows regulation of actions different users are capable of performing via different applications, such conventional approaches require an online system to maintain and update multiple applications, increasing costs and complexity for the online system. Additionally, a user authorized to perform various actions installs and maintains various applications on a client device to perform different actions in conventional approaches. This increases the complexity for a user to perform an action by having the user install, maintain, and select from multiple applications to perform different actions, which may decrease user interaction with the online system.

### SUMMARY

A venue is a geographic location, such as a geographic location associated with one or more structures. Examples of a venue include a stadium, a convention center, an arena, a theater, an amphitheater, or other suitable structure or location where people may gather for an event. In various embodiments, users obtain a ticket to enter the venue, and various events are performed at the venue. Additionally, one or more vendors are associated with the venue and provide goods or services to users attending the venue. Examples of vendors include restaurants, food service providers, beverage providers, merchandise retailers, or other suitable entities providing products or services. Each vendor uses one or more terminals to identify products or services purchased by a user. Information received by a terminal used by a vendor to retrieve or to produce a product or to provide a service to a user who purchased the product or service. For example, the terminal is a point of sale terminal identifying products provided by a vendor and prices of various products provided by the vendor. When the terminal receives an input selecting a product provided by the vendor, instructions identifying the selected product and a request to retrieve or to produce the selected product are provided to the vendor, prompting the vendor to retrieve or to produce the selected product.

To improve user interaction with the venue, an online system maintains content associated with the venue and provides an application for execution by client devices of users that allows the users to access or to modify the content associated with the venue. In various embodiments, the online system modifies functionality of the application based on contextual information received from a client device executing the application, so the application provides different functionality when executed in different contexts. Contextual information provides information about a user associated with the client device executing the application, about the client device executing the application, information about a venue (e.g., a venue associated with a user of the client device, a venue associated with a physical location within a threshold distance of a location of the client device, etc.), a combination of the preceding examples, or any other suitable information. Functionality of the application may specify content presented by the application, data maintained by the online system accessible by the application, data maintained by the online system capable of being modified by the application executing on the client device, interactions a user is capable of performing with the application, or any combination thereof.

The online system stores various configuration files that each include rules associating functionality of the application with contextual information. In some embodiments, the online system stores multiple configuration files in association with an identifier of the application, with different configuration files including rules associating different functionality with different contextual information. For example, a configuration file associated with the application identifies a set of content presented by the application and a set of actions capable of being performed on data maintained by the online system associated with contextual information specifying a particular user identifier and a particular identifier of a venue, while another configuration file associated with the application identifies an alternative set of content presented by the application and an alternative set of actions capable of being performed on data maintained by the online system associated with contextual information specifying the particular user identifier and an alternative identifier of a venue. Similarly, an additional configuration file associated with the application identifies a set of actions capable of being performed on data maintained by the online system associated with contextual information specifying the particular user identifier and a specific time interval. The online system stores various configuration files each including rules identifying associations between functionality of the application and contextual information in association with an identifier of the application in some embodiments; alternatively, the online system stores a configuration file identifying different associations between functionality of the application and contextual information in association with the identifier of the application. Hence, a configuration file identifies the functionality provided by the application when the application when the application is executed in a particular context (e.g., when a particular user executes the application, when the application is executed on a client device in a particular venue, when the application is executed during a particular time of day, etc.).

When a user executes the application on a client device, the online system receives an identifier of the application and contextual information obtained by the application from the client device. In various embodiments, the application transmits a set of contextual information obtained from data maintained by the client device to the online system. For example, the set of contextual information identifies a user identifier, a location of the client device, and a time of day; the application may obtain the user identifier from information maintained by the application on the client device, a location of the client device from a position sensor included in the client device, and a current time from the client device (e.g., from an operating system of the client device). In some embodiments, the application may prompt a user of the client device to provide contextual information (e.g., provide a user identifier or identify a venue). In some embodiments, the application obtains and transmits the contextual information and the identifier of the application when the application is initially executed by the client device; alternatively, the application obtains and transmits the contextual information and the identifier of the application at intervals during execution of the application (e.g., at a periodic intervals during execution of the application, when certain interactions are performed with the application, when certain information is modified by the application).

Based on the contextual information received from the client device, the online system selects a configuration file including contextual information matching the contextual information received from the client device. For example, the online system identifies stored configuration files associated with the identifier of the application received from the client device and selects an identified configuration file including a maximum number of rules having contextual information matching the received contextual information. In another example, the online system ranks stored configuration files associated with the identifier of the application received from the client device based on amounts of contextual information specified by rules included in various configuration files and selects a configuration file based on the ranking. For example, the online system ranks the stored configuration files so configuration files including greater numbers of rules specifying contextual information matching the received contextual information have higher positions in the ranking and selects a configuration file having a highest position in the ranking.

The online system communicates the selected configuration file to the client device executing the application, which configures the functionality specified by rules included in the selected configuration file. Because rules included in the selected configuration file are associated with contextual information, the functionality provided by the application corresponds to functionality associated with contextual information matching the contextual information received by the online system, allowing the online system to differently configure functionality provided by the application based on different contextual information received from the client device. For example, the selected configuration file identifies a set of content presented by the application when the contextual information the online system received from the client device includes an identifier of a specific venue, while another configuration file identifies an alternative set of content presented by the application when the contextual information the online system received from the client device includes an identifier of an alternative venue. As another example, a selected configuration file identifies a set of content maintained by the online system a user of the client device having a specific user identifier is capable of modifying via the application, and another selected configuration file identifies an alternative set of content maintained by the online system a user of the client device having another user identifier is capable of modifying via the application.

In some embodiments, if the online system receives additional or modified contextual information from the client device while the application is executing, the online system selects an additional configuration file and communicate the additional configuration file to the client device. As described above, the online system may receive modified contextual information from the client device when the application receives one or more inputs, when a user performs one or more interactions with the application, when a location of the client device changes, or at periodic time intervals. Based on the additional or modified contextual information, the online system selects an additional configuration file that includes rules specifying contextual information matching the additional or modified contextual information, as described above. If the additional configuration file differs from the previously selected configuration file, the online system communicates the additional configuration file to the client device, where the application replaces the previously selected configuration file that was received with the additional configuration file, which modifies the functionality of the application so the application provides functionality specified by the rules included in the additional configuration file. Hence, as the online system receives changes to the contextual information of the client device, the online system communicates with the client device to modify functionality provided by the application.

Communicating a configuration file to a client device executing an application associated with the online system allows the online system to specify different functionality of the application in different circumstances. Hence, rather than installing and maintaining multiple applications on the client device that each provide different functionality, the online system allows functionality of a single application to be modified based on contextual information provided from the client device to the online system. For example, communicating a configuration file selected based on contextual information received from the client device allows the online system to modify functionality provided by the application when a client device executing the application is in locations associated with different venues or when different users execute the application via the client device by selecting configuration rules specifying different functionality for the application based on the location of the client device or an identifier of a user executing the application. Hence, the online system allows functionality of a single application to be varied according to different contexts in which the application is executed rather than maintaining multiple applications having different functionalities specific to different contexts (e.g., for different users or for different venues).

### BRIEF DESCRIPTION OF THE DRAWINGS

FIG. 1 is a block diagram of a venue, in accordance with an embodiment.

FIG. 2 is a block diagram of a system environment including an online system, in accordance with an embodiment.

FIG. 3 is a block diagram of an online system management system, in accordance with an embodiment.

FIG. 4 is an interaction diagram a method for an online system configuring functionality of an application executing on a client device, in accordance with an embodiment.

The figures depict various embodiments for purposes of illustration only. One skilled in the art will readily recognize from the following discussion that alternative embodiments of the structures and methods illustrated herein may be employed without departing from the principles of described herein.

### DETAILED DESCRIPTION

### Venue Overview

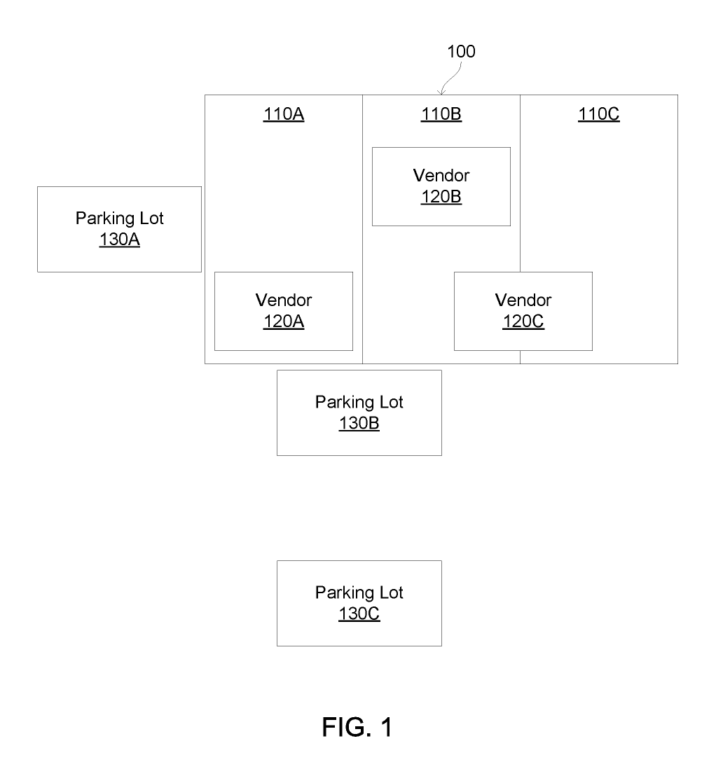

FIG. 1 is a block diagram of one embodiment of a venue 100. In the example of FIG. 1, the venue includes multiple regions 110A, 110B, 110C (also referred to individually and collectively using reference number 110). Additionally, one or more vendors 120A, 120B, 120C (also referred to individually and collectively using reference number 120) are included in the venue 100, and one or more parking lots 130A, 130B, 130C (also referred to individually and collectively using reference number 130) are associated with the venue 100. However, in other embodiments, different and/or additional components may be associated with or included in the venue 100.

The venue 100 is a geographic location, such as a geographic location associated with one or more structures. Examples of a venue 100 include a stadium, a convention center, an arena, a theater, an amphitheater, or other suitable structure. One or more regions 110 are included in the venue 100, with each region 110 corresponding to an area within the venue 100. For example, different regions 110 correspond to different sections of a stadium, different aisles of a stadium or arena, different rooms in a convention center, or any other suitable area within the venue 100. In some embodiments, an area within the venue 100 is associated with multiple regions 110 having different levels of precision. For example, a specific seat in a venue 100 is associated with a region 110 identifying a section including the seat, another region 110 identifying an aisle within the section including the seat, and an additional region identifying the specific seat. While FIG. 1 shows an example venue 100 including three regions 110A, 110B, 110C, in other embodiments, a venue 110 may include any number of regions 110.

One or more vendors 120 are included in the venue 110, with each vendor providing products or services to users within the venue 110. Examples of vendors 120 include restaurants, food service providers, beverage providers, merchandise retailers, or other suitable entities providing products or services. Different vendors 120 may be associated with different regions 110 of the venue. For example, a vendor 120A is associated with a region 110A, while a different vendor 120B is associated with a different region 110B. A vendor 110 may be associated with multiple regions 110; for example, a vendor 110C is associated with a region 110B as well as with an additional region 110C. In some embodiments, a vendor 120 is associated with a region 110 based on a distance between the vendor 120 and the region 110. For example, the vendor 120 is associated with a region 110 having a minimum distance from a location associated with the vendor 120. If a location associated with a vendor 120 is within a region 110, the vendor 120 is associated with the region 110 including the vendor's associated location.

Additionally, one or more parking lots 130A, 130B, 130C are associated with the venue 110 and identify physical locations for parking vehicles. Each parking lot includes one or more spaces, each space for parking a vehicle. A price is associated with each parking lot 130 specifying an amount of compensation a user provides to an entity associated with the venue 110 for a space in the parking lot 130 to be allocated for parking a vehicle associated with the user. Different parking lots 130 may have different distances from the venue 110, and prices associated with different parking lots 130 may be inversely proportional to a distance between a parking lot 130 and the venue 110. Each parking lot 130 is also associated with a capacity specifying a maximum number of vehicles that may be parked in a parking lot 130. The capacity may be total number of spaces in the parking lot 130 or may be a maximum number of vehicles. Information may be maintained by one or more devices included in a parking lot 130 specifying a number of spaces in the parking lot 130 in which vehicles are parked, specifying a number of vehicles within a geographic area associated with the parking lot 130, or any other suitable information. For example, a device included in the parking lot 130 increments a counter when a vehicle enters the geographic area associated with the parking lot 130 or when a vehicle is parked in a space of the parking lot 130.

### System Architecture

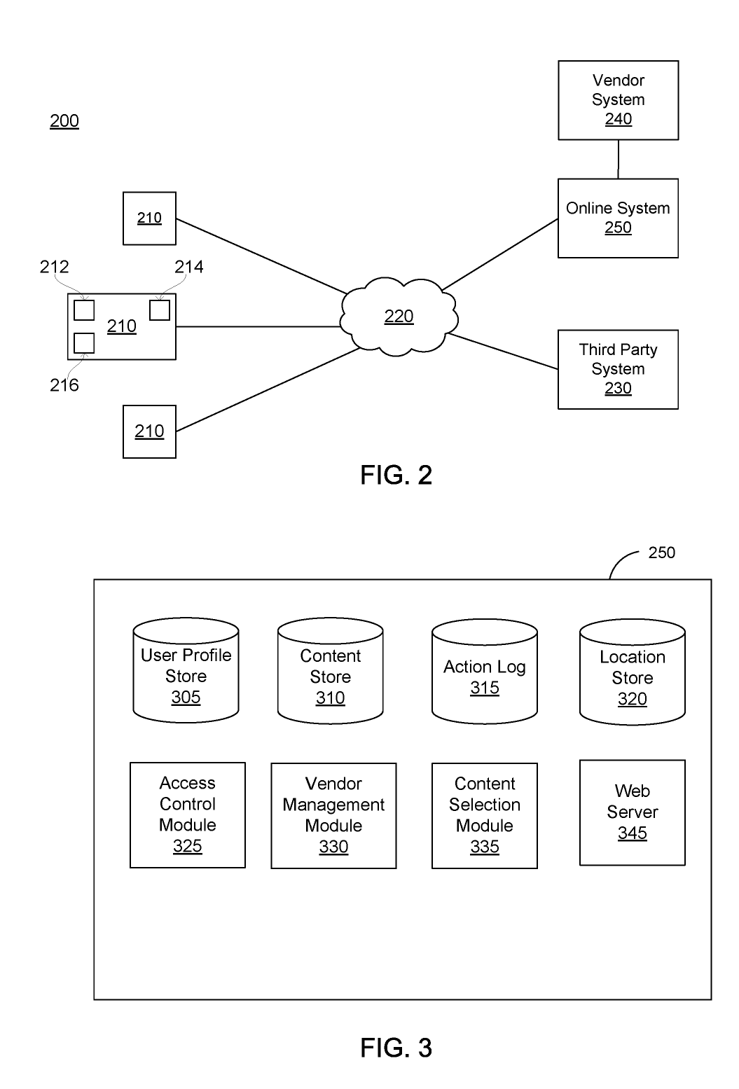

FIG. 2 is a block diagram of a system environment 200 for an online system 250. The system environment 200 shown by FIG. 1 includes various client devices 210, a network 220, a third party system 230, one or more vendor systems 240, and an online system 250. In alternative configurations, different and/or additional components may be included in the system environment 200. The embodiments described herein may be adapted to online systems other than venue management systems.

A client device 210 is one or more computing devices capable of receiving user input as well as transmitting and/or receiving data via the network 220. In one embodiment, the client device 210 is a conventional computer system, such as a desktop computer or a laptop computer. Alternatively, the client device 210 may be a device having computer functionality, such as a personal digital assistant (PDA), a mobile telephone, a smartphone or another suitable device. A client device 210 is configured to communicate with other devices via the network 220. In one embodiment, the client device 210 executes an application allowing a user of the client device 210 to interact with the online system 250. For example, the client device 210 executes a browser application to enable interaction with the online system 250 or with one or more third party system 230 via the network 220. In another embodiment, a client device 210 interacts with the online system 250 through an application programming interface (API) running on a native operating system of the client device 210, such as IOS® or ANDROID™.

A display device 212 included in a client device 210 presents content items to a user of the client device 210. Examples of the display device 212 include a liquid crystal display (LCD), an organic light emitting diode (OLED) display, an active matrix liquid crystal display (AMLCD), or any other suitable device. Different client devices 210 may have display devices 212 with different characteristics. For example, different client devices 212 have display devices 212 with different display areas, different resolutions, or differences in other characteristics.

One or more input devices 214 included in a client device 210 receive input from the user. Different input devices 214 may be included in the client device 210. For example, the client device 210 includes a touch-sensitive display for receiving input data, commands, or information from a user. Using a touch-sensitive display allows the client device 210 to combine the display device 212 and an input device 214, simplifying user interaction with presented content items. In other embodiments, the client device 210 may include a keyboard, a trackpad, a mouse, or any other device capable of receiving input from a user. Additionally, the client device may include multiple input devices 214 in some embodiments. Inputs received via the input device 214 may be processed by an application associated with the online system 250 and executing on the client device 210 to allow a client device user to exchange information with the online system 250.

Additionally, a client device 210 may include one or more position sensors 216, which determine a physical location associated with the client device 210. For example, a position sensor 216 is a global positioning system (GPS) sensor that determines a location associated with the client device 210 based on information obtained from GPS satellites communicating with the GPS sensor, such as coordinates specifying a latitude and longitude of the location associated with the client device 210. As another example, a position sensor 216 determines a location associated with the client device 210 based on intensities of signals received from one or more access points (e.g., wireless access points) by the client device 110. In the preceding example, the position sensor 216 determines a location associated with the client device 210 based on signal intensity between the client device 210 and one or more wireless access points and service set identifiers (SSIDs) or media access control (MAC) addresses of the wireless access points. However, the client device 210 may include any suitable type of position sensor 216. In various embodiments, the client device 210 may include multiple position sensors 216.

The network 220 may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

One or more third party systems 130 may be coupled to the network 220 for communicating with one or more client devices 110 or with the online system 250. In one embodiment, a third party system 230 is an application provider communicating information describing applications for execution by a client device 210 or communicating data to client devices 110 for use by an application executing on the client device 210. In other embodiments, a third party system 230 provides content or other information for presentation via a client device 210. For example, a third party system 230 provides content related to an event occurring at the venue 110 to a client device 210 for presentation to a user; as an example, the third party system 230 provides video or audio data of a portion of an event occurring at the venue to a client device 210, allowing a user associated with the client device 210 to view the portion of the event from an alternative vantage point than the user's vantage point or to hear commentary about the portion of the event. As another example, a third party system 230 is a social networking system maintaining connections between various users and providing content for presentation to users based at least in part on the maintained connections. A third party system 230 may also communicate information to the online system 250, which subsequently communicates the information, or a portion of the information, to one or more client devices 110 via the network 220.

Additionally, one or more vendor systems 240 are coupled to the online system 250 via the network 220 or through direct connections between the vendor systems 240 and the vendor management system 150. A vendor system 240 is associated with a vendor 120 and receives orders for products or services from the online system 250 and provides the products or services identified by the orders. Further, a vendor system 240 provides the online system 250 with information describing fulfillment of orders by a vendor 120 associated with the vendor system 240. For example, the vendor system 240 provides information to the online system 250 specifying an estimated time to fulfill subsequently received or pending orders for products or services, an average time in which previously received orders were fulfilled, a number of unfulfilled orders received by the vendor system 240, or other suitable information. Information provided from the vendor system 240 to the vendor management system 150 accounts for orders received via the vendor management system 150 as well as orders received by the vendor 120 associated with the vendor system 240 from users visiting a location associated with the vendor 120.

Additionally, a vendor system 240 may provide information to the online system 250 describing products or services sold by a vendor 120 associated with the vendor system 240. For example, the vendor system 240 identifies a number of different products or services sold by the vendor 120 or identifies an amount of revenue received by the vendor 120 in exchange for different products or services. Information describing sold products or services may be communicated from the vendor system 240 to the online system 250 as the products or services are sold or may be communicated from the vendor system to the online system 250 at periodic intervals. Additionally, the online system 250 may request information describing sales of products or services to a vendor system 240, which provides the requested information to the online system 250 in response to receiving the request.

The online system 250, which is further described below in conjunction with FIG. 3, receives content from one or more third party systems 230 or generates content and provides content to users via an application associated with the online system 250 and executing on client devices 210. Additionally, the online system 250 maintains information associated with one or more parking lots 130 associated with a venue 100, such as a number of spaces in a parking lot 130 currently occupied, a price associated with a the parking lot 130, or a number of spaces in the parking lot 130 that have been purchased, as well as directions for navigating to a location associated with the parking lot 130. The online system 250 may communicate certain information associated with a parking lot 130 to one or more users, such as the price associated with the parking lot 130 or directions to the location associated with the parking lot 130. Associations between one or more vendors 120 and regions 110 of the venue 100 are also included in the online system 250, which also receives orders for products or services from one or more users and communicates the orders to one or more vendors 120 for fulfillment.

FIG. 3 is a block diagram of an architecture of an online system 250. The online system 250 shown in FIG. 3 includes a user profile store 305, a content store 310, an action log 315, a location store 320, an access control module 325, a vendor management module 330, a content selection module 335, and a web server 340. In other embodiments, the social networking system 130 may include additional, fewer, or different components for various applications. Conventional components such as network interfaces, security functions, load balancers, failover servers, management and network operations consoles, and the like are not shown so as to not obscure the details of the system architecture. In other embodiments, the online system 250 is any system providing content to users.

Each user of the online system 250 is associated with a user profile, which is stored in the user profile store 305. A user profile includes declarative information about the user provided by the user and may also include information inferred by the online system 250 from actions associated with the user or from other information. In one embodiment, a user profile includes multiple data fields, each describing one or more attributes of the corresponding user. Examples of information stored in a user profile include demographic information, contact information, preferences, and location information. For example, a user profile identifies a region 110 of the venue 100 associated with a user, such as a region 110 including a seat associated with a ticket to attend the venue 100 associated with the user. A user profile may also store other information provided by the user, for example, image data or video data. Additionally, a user profile in the user profile store 205 may also maintain references to actions by the corresponding user performed on content presented by the online system 250 or interactions between the corresponding user captured by one or more vendor systems 240 and communicated to the online system 250. For example, a user profile identifies prior orders for products or services the online system 250 received from a user and communicated to one or more vendor systems 150.

In some embodiments, a user profile includes a status associated with the user. The online system 250 may provide different functionality to a user based on the user's status. For example, the online system 250 communicates certain types of messages to client devices 210 associated with users having a specific type of status and does not communicate the certain types of messages to client devices 210 associated with users that do not have the specific type of status. As another example, the online system 250 presents less advertisement content to users having specific statuses. The status may be based on a frequency with which the user is associated with tickets to attend the venue 100 or an amount of money the online system 250 has received from the user (e.g., based on an amount the user has spent on tickets to attend the venue 100). Additionally, a user may provide an amount of compensation to the online system 250 for a specific status to be associated with the user. For example, the user provides the online system 250 with an amount of compensation per year or per month for the online system 250 to associate a specific status with the user.

The content store 310 stores objects that each represents various types of content received from one or more third party systems 230 or generated by the online system 250. Examples of content represented by an object include video data associated with an event occurring at the venue 100, image data associated with an event occurring at the venue 100, audio data associated with an event occurring at the venue 100, text data associated with an event occurring at the venue 100, information associated with the venue 100 or with the location of the venue 100, or other suitable. Additionally, content may be received from applications associated with a third party system 230 and executing on client devices 210 associated with users of the venue management system 230. In one embodiment, objects in the content store 210 represent single pieces of content, or content “items.”

The action log 315 stores information describing actions performed by venue management system users internal to or external to the online system 250. For example, actions performed by a user on a third party system 230 that communicates information to the online system 250 are stored in the action log 315 along with information describing actions performed by the user through the online system 250. Examples of actions include: ordering a product or service from a vendor 120 included in the venue 100, checking-into the venue, accessing content provided by the online system 250 or provided by a third party system 230 that communicates with the online system 250, providing a review of a product, service, or vendor 120 to the online system 250 or to a third party system 230 that communicates with the vendor management system 250, providing a comment associated with the venue 100 or with an event occurring at the venue 100 to the online system 250 or to a third party system 230 that communicates with the online system 250. However, any suitable action may be stored in the action log 315 and associated with a user profile in the user profile store 305. Information in the action log 315 may identify the user performing an action, a type of the action, a description of the action, a time associated with the action, or any other suitable information. In some embodiments, data from the action log 315 is used to infer interests or preferences of a user, augmenting interests included in the user's user profile and allowing a more complete understanding of user preferences.

The action log 315 may also store user actions taken on a third party system 230, such as an external website, and communicated to the online system 250. For example, an e-commerce website may recognize a user of the online system 250 through a plug-in enabling the e-commerce website to identify the venue management system user. Because users of the online system 250 are uniquely identifiable, third party systems 230 may communicate information about a user's actions outside of the online system 250 to the online system 250 for association with the user. Hence, the action log 315 may record information about actions users perform on a third party system 230, such as purchases made, comments on content, or other information a user authorizes a third party system 230 to communicate to the vendor management system 250.

The location store 320 includes physical locations associated with various regions 110 of the venue 100. In various embodiments, the location store 320 includes a region identifier associated with each region 110 and information identifying a geographic area associated with the region identifier. Any suitable information may identify the geographic area associated with a region identifier. Example information identifying a geographic area of a region 110 include: physical coordinates specifying boundaries of a region 110 and an identifier of a portion of the venue 100 including the region 110. Additionally, the location store 320 includes data associating vendors 120 with one or more regions 110 of the venue 100. A vendor identifier uniquely associated with a vendor 120 is associated with a region identifier, with the association stored in the location store 320. Multiple vendors 120 may be associated with a region 110 of the venue 100.

In some embodiments, the location store 320 also associates location information with users of the online system 250. A client device 210 communicates location information to the online system 250, which may store the location information in the location store 320 or in the user profile store 305 in association with the user. Based on the received information, the online system 250 may determine a region 110 of the venue including the location information and associate the region identifier of the determined region with a user profile corresponding to the user. If the online system 250 receives modified location information from the client device 210, the venue management system 205 may modify the determined region 110 if a different region includes the modified location information. Alternatively, one or more sensors included in the venue 100 identify a client device 210 and determine a location associated with the client device 210. Based on the determined location, the online system 250 identifies a region 110 including the client device 110 and stores a region identifier of the region 110 in association with a user identifier of a user associated with the client device 210. In various embodiments, information identifying a location associated with the client device 210 (e.g., latitude and longitude) is also stored in the location store 320 in association with an identifier associated with the user associated with the client device 210. Additionally, the online system 250 may assign a location to a user and store the assigned location in association with the user in the location store 320. For example, when a user purchases a ticket to enter the venue 100, the ticket is associated with a location assigned to the user, and the location store 320 includes information associating the location assigned to the user from the ticket with an identifier associated with the user.

The access control module 325 maintains rules each associating functionality of an application associated with the online system 250 with contextual information. Contextual information may describe characteristics of a user associated with a client device executing the application, characteristics of a venue associated with the client device executing the application, characteristics of a client device 210 executing the application, temporal information, or any other suitable information describing execution or interaction with the application via a client device 210. Functionality of the application includes content presented by the application, layout or formatting of content presented by the application, interactions capable of being performed by users with content maintained by the application or by the online system 250 via the application, or content maintained by the online system 250 that the application is authorized to access or to modify. A rule associates functionality provided by the application when certain contextual information is associated with execution of the application. For example, a rule identifies a set of actions the application is authorized to perform on stored content when a user identifier corresponds to a user profile in the user profile store 305 having a specific characteristic (e.g., a specific job title). Another rule may identify a layout of content presented by the application when a user accessing the application has a user profile maintained by the online system 250 including a specific characteristic; for example, a rule identifies a set of content presented by the application when a user profile maintained by the online system 250 for a user accessing the application includes a particular job title, while another rule identifies an alternative set of content presented by the application when a user profile maintained by the online system 250 for the user accessing the application includes an alternative job title. Other rules associate information maintained by the online system 250 with identifiers of venues 100, so different content is presented by the application when contextual information identifies different venues 100. In another example, rules identify sets of content presented by the application when contextual information identifies different times of day. The access control module 325 may store any number of rules in various embodiments.

Based on the stored rules, the access control module 325 generates one or more configuration files. Each configuration file includes a set of rules identifying functionality provided by the application in response to contextual information. In some embodiments, the access control module 325 generates a configuration file based on information received from an interface provided to a user by the online system via a client device. For example, the access control module 325 generates graphical representations of different functionalities for the application and graphical representations of different contextual information. The graphical representations of the functionalities and of the contextual information are communicated from by the access control module 325 to a client device 210 for presentation to a user, who generates an association between one or more functionalities and contextual information by selecting the one or more functionalities and selecting the contextual information via the client device 210. In various embodiments, the access control module 325 provides the graphical representations of the functionalities and of the contextual information to users having certain characteristics in user profiles maintained by the user profile store 305 (e.g., users having a particular job title in their user profiles) or to users included in a set of users provided by a venue 100 associated with the application. Information identifying the generated association is communicated from the client device 210 to the access control module 325, which generates a configuration file including one or more rules associating the selected one or more functionalities with the selected contextual information.

In some embodiments, the access control module 325 generates multiple configuration files associated with an application, with different configuration files including different associations between functionalities and contextual information. For example, the access control module 325 configuration files that associate different functionalities with different characteristics of a user (e.g., different user identifiers, different characteristics in user profiles associated with users, etc.) or that associate different functionalities with identifiers of different venues 100. Alternatively, the access control module 325 a single configuration file associated with eth application, where the single configuration file includes different rules associating different functionalities with different contextual information. Generated configuration files are stored in the access control modules 325 in association in association with identifiers of applications for which the configuration files were generated.

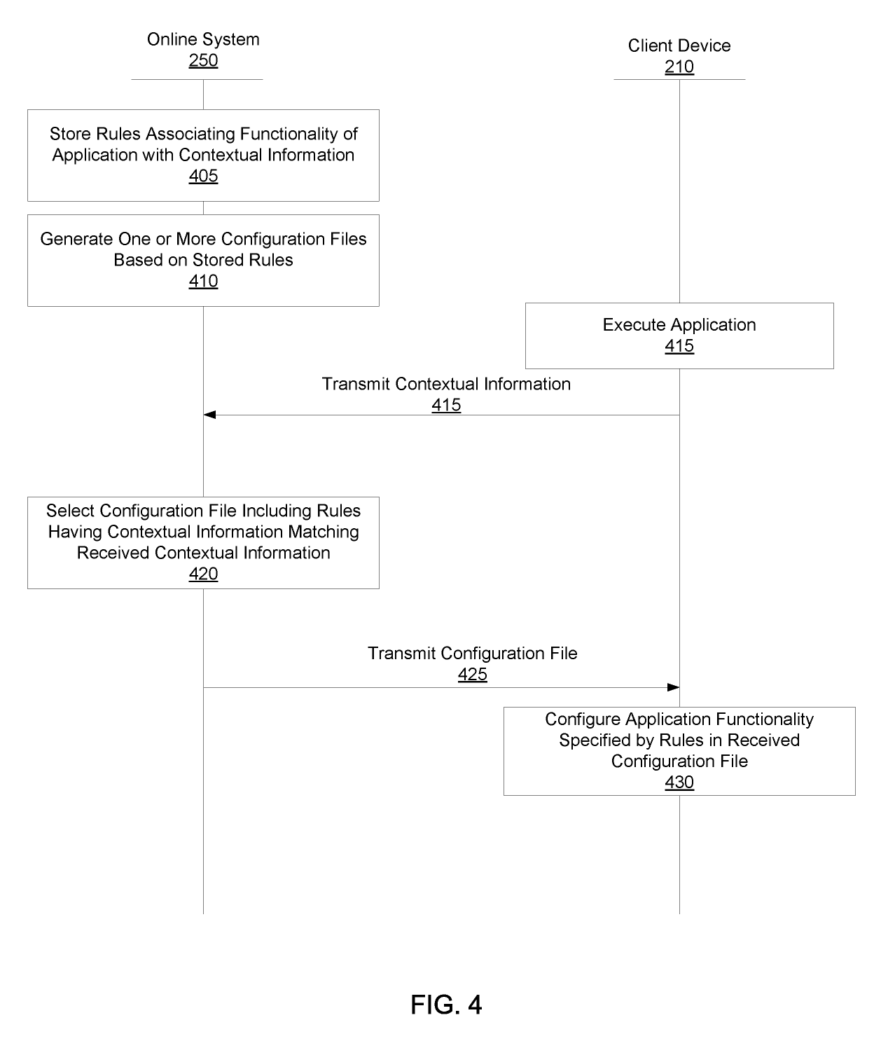

As further described below in conjunction with FIG. 4, when a user executes an application on a client device, the access control module 325 receives an identifier of the application (e.g., an application name, an identifier associated with the application by the online system 250) and contextual information from the client device 210. In various embodiments, the application includes information identifying a set of contextual information obtained from data maintained by the client device 210.

Based on the contextual information received from the client device 210, the access control module 325 selects 420 a configuration file including contextual information matching the contextual information received from the client device 210. For example, the access control module 325 identifies stored configuration files associated with the identifier of the application received from the client device 210 and selects an identified configuration file including a maximum number of rules having contextual information matching the received contextual information. In another example, the access control module 325 ranks stored configuration files associated with the identifier of the application received from the client device 210 based on amounts of contextual information specified by rules included in various configuration files and selects a configuration file based on the ranking. Selection of a configuration file is further described below in conjunction with FIG. 4.

The access control module 325 communicates the selected configuration file to the client device 210, causing the application executing on the client device 210 to configure functionality provided to a user based on the rules included in the selected configuration file. Communicating a configuration file to the client device 210 specifying functionality provided by the application associated with the online system 250, the access control module 325 allows the application to provide different functionality in different circumstances. Hence, rather than maintaining multiple applications on the client device 210 to perform different functionalities, the access control module 325 allows a single application to provide context-specific functionality, as further described below in conjunction with FIG. 4.

The vendor management module 330 receives orders for products or services from client devices 210 associated with users and communicates the orders to one or more vendor systems 240 of vendors 120 associated with the venue 100. In various embodiments, the vendor management module 330 includes vendor profiles each associated with one or more vendors 120 associated with the venue 100. A vendor profile includes a vendor identifier uniquely identifying a vendor 120 and additional information associated with the vendor 120, such as one or more regions 110 of the venue 100 associated with the vendor 120 and information for communicating with a vendor system 240 associated with the vendor 120. Further examples of information associated with the vendor 120 and included in a vendor profile include: contact information, hours of operation, a listing of products or services provided by the vendor 120, a current inventory or products maintained by the vendor 120, and a current time for the vendor 120 to fulfill received orders. However, in other embodiments, additional or different information may be included in the vendor profile. One or more users authorized by the online system 250 may communicate information to the vendor management system 330 to modify regions 110 of the venue associated with one or more vendors 120.

When the vendor management module 330 receives an order identifying a product or service and identifying a vendor 120 from a user, the vendor management system 330 communicates the order to a vendor system 240 corresponding to the identified vendor 120. The vendor 120 may subsequently deliver the product or service identified by the order to the user or may communicate a notification to the user via the online system 250 when the order is fulfilled. To expedite delivery of products or services, the vendor management module 330 may associate different vendors 120 with different regions 110 or the venue 100 to reduce time for users to receive products or services delivered by vendors 120. The vendor management module 330 may modify regions 110 of the venue 100 associated with a vendor 120 by modifying identifiers of regions 110 included in a vendor profile of a vendor 120. In some embodiments, the vendor management module 330 modifies regions 110 associated with a vendor 120 based on a number or a frequency of orders received from users associated with different regions 110 as well as time to fulfill orders by different vendors 120, products or services offered by different vendors 120, and number of orders received by different vendors 120. When modifying regions 110 associated with a vendor 120 or vendors 120 associated with a region, the venue management system 330 may account for products or services provided by various vendors 120 so similar products or services are provided to users in a region 110 before and after modification of the vendors 120 associated with the region 110.

Additionally, the vendor management module 330 receives information from a vendor system 240 and communicates the information to one or more client devices 210 for presentation to users. For example, the vendor 240 communicates a time to fulfill an order, an estimated time to fulfill an order, a number of previously received orders that have yet to be fulfilled, or other suitable information to the vendor management module 330, which provides at least a subset of the information to a client device 210 for presentation to a user. As another example, a vendor system 250 communicates a message to the venue management module 330 including a user identifier, an order identifier (or a description of an order), and an indication that an order corresponding to the order identifier has been fulfilled by a vendor. The vendor management module 330 identifies a user corresponding to the user identifier from the user profile store 305 and communicates the message to a client device 210 associated with the user.

As vendors 120 may deliver products to users in various regions 110 of the venue 100 to fulfill orders received from various users, in some embodiments, the vendor management module 330 regulates communication of orders received from client devices 210 associated with users to vendor systems 240 associated with various vendors 120. When the vendor management module 330 receives an order for a product or service from a client device 210 associated with a user, the vendor management module 330 stores the received order in a queue for a specified time interval before communicating the order to a vendor system 240 corresponding to a vendor 120 identified by the order. If the vendor management system 330 receives additional orders from users having one or more characteristics matching or similar to the order stored in the queue and identifying the vendor 120 identified by the order while the order is stored in the queue, the vendor management module 330 generates a group including the additional orders and the order stored in the queue and communicates the group or orders to a vendor system 240 associated with the vendor 120 to be fulfilled. For example, the vendor management system 330 generates a group including additional orders associated with users having a location matching a location of a user associated with an order stored in the queue. As additional examples, the vendor management system 330 generates a group including orders identifying products or services matching or similar to a product or service specified by an order stored in the queue or generates a group including orders identifying products or services having times for fulfillment within a threshold value of a time for fulfillment of the order stored in the queue. Communicating a group of orders having one or more matching or similar characteristics to a vendor system 240 allows the vendor 120 associated with vendor system 240 to more efficiently fulfill orders from users.

The content selection module 335 selects one or more content items for communication to a client device 210 for presentation to a user. Content items eligible for presentation to the user are retrieved from the content store 310, from a third party system 230, or from another source, by the content selection module 335, which selects one or more of the content items for presentation to the user. A content item eligible for presentation to the viewing user is a content item associated with at least a threshold number of targeting criteria satisfied by characteristics of the user or is a content item that is not associated with targeting criteria. For example, a content item associated with targeting criteria specifying a threshold distance of the venue 100 is identified as eligible for presentation to users associated with locations within a threshold distance of the venue 100. As another example, a content item associated with targeting criteria specifying attendance of an event at the venue 100 is identified as eligible for presentation to users attending the event or who have indicated they will attend the event. In various embodiments, the content selection module 335 includes content items eligible for presentation to the user in one or more selection processes, which identify a set of content items for presentation to the user. For example, the content selection module 335 determines a measure of relevance of various content items to a user based on characteristics associated with the user by the online system 250 based on actions associated with the user by the online system 250, characteristics of the user maintained by the online system 250, preferences of the user maintained by the online system 250, and characteristics of content items eligible for presentation to the user. For example, the content selection module 335 determines measures of relevance to a user based on characteristics of the content items, characteristics of the user, and actions associated with the user. Based on the measures of relevance, the content selection module 335 selects one or more content items for presentation to the user (e.g., content items having at least a threshold measure of relevance, content items having highest measures of relevance relative to other content items). In some embodiments, the content selection module 335 ranks content items based on their associated measures of relevance and selects content items having the highest positions in the ranking or having at least a threshold position in the ranking for presentation to the user.

A content item may be associated with bid amounts specifying an amount of compensation received by the online system 250 from a third party system 130 or from a user if one or more criteria associated with the content item are satisfied. For example, a bid amount associated with a content item specifies an amount of compensation received by the online system 250 when the content item is presented to a user or when a user presented with the content item performs a specified type of interaction with the content item. The content selection module 335 uses the bid amounts associated with various content items when selecting content for presentation to the user. In various embodiments, the content selection module 335 determines an expected value associated with various content items based on their bid amounts and selects content items associated with a maximum expected value or associated with at least a threshold expected value for presentation to the user. An expected value associated with a content item represents an expected amount of compensation to the online system 250 for presenting a content item. For example, the expected value associated with a content item is a product of the content item's bid amount and a likelihood of the user interacting with the content item. The content selection module 335 may rank content items associated with bid amounts separately than content items that are not associated with bid amounts and select content items for presentation based on the separate rankings (e.g., content items having at least a threshold position in a ranking)

The web server 340 links online system 250 via the network 220 to one or more client devices 210, as well as to one or more third party systems 230. Additionally, the web server 340 may exchange information between the online system 250 and one or more vendor systems 240. The web server 340 serves web pages, as well as other content, such as JAVA®, FLASH®, XML and so forth. The web server 340 may receive and route messages between the online system 250 and a client device 210, for example, instant messages, queued messages (e.g., email), text messages, short message service (SMS) messages, or messages sent using any other suitable messaging technique. A user may send a request to the web server 340 to upload information (e.g., images or videos) that are stored in the content store 210. Additionally, the web server 340 may provide application programming interface (API) functionality to send data directly to native client device operating systems, such as IOS®, ANDROID™, or BlackberryOS.

### Configuration of Application Functionality by an Online System

FIG. 4 is an interaction diagram of one embodiment of a method for configuring functionality of an application executing on a client device 210 by an online system 250. In other embodiments, the method may include different and/or additional steps than those described in conjunction with FIG. 4. Additionally, in other embodiments, steps of the method may be performed in orders different than the order described in conjunction with FIG. 4.

An online system 250 provides an application associated with the online system 250 to various client devices 210, allowing users of the client devices 210 to access information maintained by the online system 250, to modify information maintained by the online system 250, or to store information using the online system 250. To regulate access to information or modification of information by various users, the application may provide different functionality based on contextual information obtained from a client device 210 executing the application. Contextual information provides information about a user associated with the client device 210 executing the application, about the client device 210 executing the application, information about a venue 100 (e.g., a venue 100 associated with a user of the client device 250, a venue 100 associated with a physical location within a threshold distance of a location of the client device 250, etc.), or any other suitable information. Based on the contextual information, the application provides functionality to a user of the client device 210 executing the application. For example, the application provides different functionality to different users associated with a venue 100 (e.g., users having different job titles within the venue 100, users with different lengths of time employed by the venue 100). As another example, the application allows users associated with a venue 100 to access information associated with the venue 100 and maintained by the online system 250, while preventing the users associated with the venue 100 from accessing information associated with other venues 100 maintained by the online system 250.

Additionally, content presented by the application may be based on contextual information from the client device 210 executing the application. For example, content presented by the application is different when the application is executed at different times of day. In another example, content presented by the application is based on a location of the client device 210 executing the application (e.g., a location within a venue 100, a physical location). However, any suitable contextual information may be used by the application or by the online system 250 to select or to modify content presented by the application.

To configure functionality of an application associated with the online system 250, the online system 250 stores 405 various rules, each rule associating functionality of the application associated with the online system 250 with contextual information. As described above, contextual information may describe characteristics of a user associated with a client device 210 executing the application, characteristics of a venue 100 associated with the client device 210 executing the application, characteristics of the client device 210 executing the application, temporal information, or any other suitable information describing execution or interaction with the application via a client device 210. Functionality of the application includes presentation of content by the application, interactions with content maintained by the application or by the online system 250 via the application. For example, a rule identifies a set of actions the application is authorized to perform on stored content when a user identifier corresponds to a user profile maintained by the online system 250 having a specific characteristic (e.g., a specific job title). Another rule may identify a layout of content presented by the application when a user accessing the application has a user profile maintained by the online system 250 including a specific characteristic; for example, a rule identifies a set of content presented by the application when a user profile maintained by the online system 250 for a user accessing the application includes a particular job title, while another rule identifies an alternative set of content presented by the application when a user profile maintained by the online system 250 for the user accessing the application includes an alternative job title. Other rules associate information maintained by the online system 250 with identifiers of venues 100, so different content is presented by the application when contextual information identifies different venues 100. In another example, rules identify sets of content presented by the application when contextual information identifies different times of day. The online system 250 may store 405 any number of rules in various embodiments.

Based on the stored rules, the online system 250 generates 410 one or more configuration files. Each configuration file includes a set of rules identifying functionality provided by the application in response to contextual information. In some embodiments, the online system 250 generates 410 a configuration file based on information received from an interface provided to a user by the online system 250 via a client device 210. For example, the online system 250 generates graphical representations of different functionalities for the application and graphical representations of different contextual information. The graphical representations of the functionalities and of the contextual information are communicated from the online system 250 to a client device 210 for presentation to a user, who generates an association between one or more functionalities and contextual information by selecting the one or more functionalities and selecting the contextual information via the client device 210. In various embodiments, the online system 250 provides the graphical representations of the functionalities and of the contextual information to users having certain characteristics in user profiles maintained by the online system 250 (e.g., users having a particular job title in their user profiles) or to users included in a set of users provided by a venue 100 associated with the application. Information identifying the generated association is communicated from the client device 210 to the online system 250, which generates 410 a configuration file including one or more rules associating the selected one or more functionalities with the selected contextual information. For example, the online system 250 generates a JAVASCRIPT® Object Notation file including one or more of the stored rules associating the selected one or more functionalities with the selected contextual information. Providing graphical representations of contextual information and functionalities of the application allows a user of the online system 250 to more easily generate 410 the configuration file by simplifying identification of functionalities and contextual information as well as simplifying creation of associations between functionalities and contextual information.

In some embodiments, the online system 140 generates 410 multiple configuration files associated with an application, with different configuration files including different associations between functionalities and contextual information. For example, the online system 140 generates 410 configuration files that associate different functionalities with different characteristics of a user (e.g., different user identifiers, different characteristics in user profiles associated with users, etc.) or that associate different functionalities with identifiers of different venues 100. Alternatively, the online system 140 generates 410 a single configuration file associated with eth application, where the single configuration file includes different rules associating different functionalities with different contextual information. The online system 250 stores the generated configuration file, or the generated configuration files, in association with an identifier of the application.

When a user executes 415 the application on a client device 210, the client device 210 transmits 420 an identifier of the application (e.g., an application name, an identifier associated with the application by the online system 250) and contextual information to the online system 250. The application obtains the contextual information from information maintained by the client device 210. In various embodiments, the application includes information identifying a set of contextual information obtained from data maintained by the client device 210. For example, the set of contextual information identifies a user identifier, a location of the client device 210, and a time of day; the application obtains the user identifier from information maintained by the application on the client device 210, a location of the client device 210 from a position sensor 216 included in the client device 210, and a current time from the client device 210 (e.g., from an operating system of the client device 210). In some embodiments, the application may prompt a user of the client device 110 to provide contextual information (e.g., provide a user identifier or identify a venue 100). The application may obtain any suitable contextual information in various embodiments. In some embodiments, the application obtains and transmits 415 the contextual information and the identifier of the application when the application is initially executed by the client device 210; alternatively, the application obtains and transmits 415 the contextual information and the identifier of the application at intervals during execution of the application (e.g., at a periodic intervals during execution of the application, when certain interactions are performed with the application, when certain information is modified by the application).

Based on the contextual information received from the client device 210, the online system 250 selects 420 a configuration file including contextual information matching the contextual information received from the client device 210. For example, the online system 250 identifies stored configuration files associated with the identifier of the application received from the client device 210 and selects 420 an identified configuration file including a maximum number of rules having contextual information matching the received contextual information. In another example, the online system 250 ranks stored configuration files associated with the identifier of the application received from the client device 210 based on amounts of contextual information specified by rules included in various configuration files and selects 420 a configuration file based on the ranking. For example, the online system 250 ranks the stored configuration files so configuration files including greater numbers of rules specifying contextual information matching the received contextual information have higher positions in the ranking and selects 420 a configuration file having a highest position in the ranking.

The online system 250 communicates 425 the selected configuration file to the client device 210 executing the application, which configures 430 the functionality specified by rules included in the selected configuration file. Hence, the rules included in the selected configuration file determine the functionality provided by the application. Because rules included in the selected configuration file are associated with contextual information, the functionality provided by the application corresponds to functionality associated with contextual information matching the contextual information received by the online system 250; this allows the online system 250 to differently determine functionality provided by the application based on the contextual information received from the client device 210. For example, the selected configuration file identifies a set of content presented by the application when the contextual information the online system 250 received from the client device 210 includes an identifier of a specific venue 100, while another configuration file identifies an alternative set of content presented by the application when the contextual information the online system 250 received from the client device 210 includes an identifier of an alternative venue 100. As another example, a selected configuration file identifies a set of content maintained by the online system 250 a user of the client device 210 having a specific user identifier is capable of modifying via the application, and another selected configuration file identifies an alternative set of content maintained by the online system 250 a user of the client device 210 having another user identifier is capable of modifying via the application.

In some embodiments, if the online system 250 receives additional or modified contextual information from the client device 210 while the application is executing, the online system 250 selects 420 an additional configuration file and communicate 425 the additional configuration file to the client device 210. As described above, the online system 250 may receive modified contextual information from the client device 210 when the application receives one or more inputs, when a user performs one or more interactions with the application, when a location of the client device 210 changes, or at periodic time intervals. Based on the additional or modified contextual information, the online system 250 selects 420 an additional configuration file that includes rules specifying contextual information matching the additional or modified contextual information, as described above. If the additional configuration file differs from the previously selected configuration file, the online system 250 communicates 425 the additional configuration file to the client device 210, where the application replaces the previously selected configuration file that was received with the additional configuration file, which modifies the functionality of the application so the application provides functionality specified by the rules included in the additional configuration file. Hence, as the online system 250 receives changes to the contextual information of the client device 210, the online system 250 communicates with the client device 210 to modify functionality provided by the application.

By communicating a configuration file to the client device 210 that specifies functionality provided by the application associated with the online system 250, the online system 250 allows the application to provide different functionality in different circumstances. Hence, rather than installing and maintaining multiple applications on the client device 210 to perform different functionality, the online system 250 allows functionality of a single application to be modified based on contextual information provided from the client device 210 to the online system 250. For example, communicating a configuration file selected based on contextual information received from the client device 210 allows the online system 250 to modify functionality of the application associated with the client device 210 based on information associated with a user identifier by the online system 250 (e.g., a job title associated with the user identifier by the online system 250, an employer associated with the user identifier by the online system 250), a location of the client device 210 (e.g., a venue 100 including the client device 210, a location within a venue 100 including the client device), a time of day, or other contextual information affecting execution of the application associated with the online system 210. Hence, the online system 250 provides a single application having functionality capable of being modified based on different contexts in which the application is executed rather than providing multiple applications having different functionalities specific to different contexts (e.g., for different users or for different venues 100).

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing one or more rules at an online system, each rule associating contextual information with functionality of an application associated with the online system;
generating one or more configuration files from the stored one or more rules, each configuration file including a set of rules identifying functionality provided by the application in response to contextual information;
receiving contextual information from a client device executing the application;
selecting a configuration file including contextual information matching the contextual information received from the client device executing the application and including information identifying functionality provided by the application; and
communicating the selected configuration file identifying functionality provided by the application executing to the client device.

2. The method of claim 1, wherein contextual information includes a time of day.

3. The method of claim 2, wherein different rules associate different functionality of the application with different times of day.

4. The method of claim 1, wherein contextual information includes an identifier of a venue.

5. The method of claim 4, wherein different rules associate different functionality of the application with identifiers of different venues.

6. The method of claim 1, wherein contextual information includes an identifier of a user of the client device.

7. The method of claim 6, wherein different rules associate different functionality of the application with identifiers of different users of the client device.

8. The method of claim 1, wherein the set of rules identifying functionality provided by the application in response to contextual information identifies a set of information presented by the application in response to the contextual information received from the client device.

9. The method of claim 1, wherein selecting the configuration file including contextual information matching the contextual information received from the client device executing the application and including information identifying functionality provided by the application comprises:
identifying stored configuration files associated with an identifier of the application; and
selecting an identified stored configuration file including a maximum number of rules having contextual information matching the contextual information received from the client device executing the application.

10. The method of claim 1, wherein selecting the configuration file including contextual information matching the contextual information received from the client device executing the application and including information identifying functionality provided by the application comprises:
identifying stored configuration files associated with an identifier of the application;
ranking the identified stored configuration files based on amounts of contextual information in rules included in each of the identified stored configuration files matching the contextual information received from the client device executing the application; and
selecting an identified stored configuration file based on the ranking.

11. A computer program product comprising a computer readable storage medium having instructions encoded thereon that, when executed by a processor, cause the processor to:
store one or more rules at an online system, each rule associating contextual information with functionality of an application associated with the online system;
generate one or more configuration files from the stored one or more rules, each configuration file including a set of rules identifying functionality provided by the application in response to contextual information;
receive contextual information from a client device executing the application;
select a configuration file including contextual information matching the contextual information received from the client device executing the application and including information identifying functionality provided by the application; and
communicate the selected configuration file identifying functionality provided by the application executing to the client device.

12. The computer program product of claim 11, wherein contextual information includes a time of day.

13. The computer program product of claim 12, wherein different rules associate different functionality of the application with different times of day.

14. The computer program product of claim 11, wherein contextual information includes an identifier of a venue.

15. The computer program product of claim 14, wherein different rules associate different functionality of the application with identifiers of different venues.

16. The computer program product of claim 11, wherein contextual information includes an identifier of a user of the client device.

17. The computer program product of claim 16, wherein different rules associate different functionality of the application with identifiers of different users of the client device.

18. The m computer program product of claim 11, wherein the set of rules identifying functionality provided by the application in response to contextual information identifies a set of information presented by the application in response to the contextual information received from the client device.

19. The computer program product of claim 11, wherein select the configuration file including contextual information matching the contextual information received from the client device executing the application and including information identifying functionality provided by the application comprises:
identify stored configuration files associated with an identifier of the application; and
select an identified stored configuration file including a maximum number of rules having contextual information matching the contextual information received from the client device executing the application.

20. The computer program product of claim 11, wherein select the configuration file including contextual information matching the contextual information received from the client device executing the application and including information identifying functionality provided by the application comprises:
identify stored configuration files associated with an identifier of the application;
rank the identified stored configuration files based on amounts of contextual information in rules included in each of the identified stored configuration files matching the contextual information received from the client device executing the application; and
select an identified stored configuration file based on the ranking.
